(19) United States
(12) Patent Application Publication
(10) Pub. No.: US 2006/0168385 A1
(43) Pub. Date: Jul. 27, 2006

(54) Interrupt controller for a microprocessor

(76) Inventor: Rudiger Brunheim, Unterkirnach (DE)

Correspondence Address: THOMSON LICENSING INC., PATENT OPERATIONS, PO BOX 5312, PRINCETON, NJ, 08543-5312, US

(21) Appl. No.: 11/300,801

(22) Filed: Dec. 15, 2005

Related U.S. Application Data
(63) Continuation-in-part of application No. 10/451,350, filed on Jun. 19, 2003.

(30) Foreign Application Priority Data
Dec. 20, 2000 (DE) 10063936.4

(51) Int. Cl. G06F 13/24

(52) U.S. Cl. 710/260

(57) ABSTRACT

An interrupt controller for a microprocessor having a plurality of event memories which are combined to form at least one group and each having an input for a setting signal and an output for an event memory signal which portrays the state of the event memory. The setting signal for an event memory becomes active when activation of an event signal associated with this event memory is detected. The event memory signals are connected to an interrupt signal for the microprocessor. The microprocessor has read and write access to the event memory signals via a data bus. The event memories each have an input for a resetting signal. The resetting signal in a group becomes active when the microprocessor effects write access to the group containing this event memory using a first write signal and, at the same time, that individual signal from the microprocessor which is associated with this event memory is active on the data bus. A means for ensuring that the resetting signal for an event memory becomes not active if the state of an event memory 40 is altered by new events during reading or between reading and resetting the event memory 40.

### CROSS-REFERENCE TO RELATED APPLICATIONS

This application claims the benefit, under 35 U.S.C.§365 of International Application PCT/EP01/14611, filed Dec. 12, 2001, which was published in accordance with PCT Article 21(2) on Apr. 18, 2002 in English and which claims the benefit of German patent application No. 10063936.4, filed Dec. 20, 2000. This application is a continuation-in-parts based on U.S. patent application Ser. No. 10/451,350 filed on Jun. 19, 2003.

### FIELD OF THE INVENTION

The invention relates to an interrupt controller for a microprocessor having a plurality of event memories which are combined to form at least one group and each have an input for a setting signal and an output for an event memory signal which portrays the state of the event memory, where the setting signal for an event memory becomes active when activation of an event signal associated with this event memory is detected, where the event memory signals are connected to an interrupt signal for the microprocessor, where the microprocessor has read and write access to the event memory signals via a data bus, and where the event memories each have an input for a resetting signal. This interrupt controller is intended for use, by way of example, in devices for recording or reproducing information on an optical information medium.

### BACKGROUND OF THE INVENTION

Interrupt controllers interrupt the program execution in a microprocessor when particular events occur, so that the microprocessor is able to execute a program routine, called an interrupt routine, before the interrupted program execution is continued. The occurrence of such an event is signaled to the microprocessor in the form of an interrupt signal when activation of a corresponding event signal is detected. According to the use or task of the microprocessor, each event signal or interrupt signal may have a dedicated interrupt routine associated with it. Alternatively, different event signals or interrupt signals can be assigned the same interrupt routine.

In addition, interrupt controllers are known which can be used to activate or deactivate individual interrupt signals specifically. Since it may sometimes not be possible to interrupt program execution and the interrupt signal may actually be inactive again by the time interruption is possible again, the activation of an event signal is generally stored until the microprocessor actually executes the associated interrupt routine. For this purpose, an “event memory” is provided which is set when activation of an event signal is detected—for example as a result of edge detection—and which is reset when the associated interrupt routine is executed.

Resetting of the event memories can, in principle, be triggered either by the microprocessor itself without influence by the interrupt routine or by program instructions in the interrupt routine.

Resetting of the event memories exclusively by the microprocessor without program influence is generally possible only if each interrupt signal has a dedicated interrupt routine associated with it and a means of deactivating the interrupt signal is arranged upstream of the event memory.

However, the means of deactivating the interrupt signal is typically arranged downstream of the event memory, so that events which occurred during brief deactivation of the interrupt signal can also be processed. However, this arrangement demands that it be possible to reset the event memory associated with a deactivated interrupt signal selectively on a specific basis before renewed activation in order to prevent an interruption from being unintentionally triggered by an event which is a long way in the past, for example in the case of a long period of deactivation. This requires a means of resetting using program commands.

If a particular interrupt routine is called by different events and hence by different interrupt signals, the interrupt routine is generally able to establish which event or which events have triggered the interrupt routine. For this purpose, the microprocessor has read access to the event memory signals. The event memories are reset only when the interrupt routine has read the state of the event memories. This also requires a means of resetting using program commands.

In practice, the event memories are often combined into groups for access by the microprocessor in order to improve effectiveness. Thus, for example in the case of a microprocessor having a data bus width of 8 bits, 8 respective event memories are combined to form an 8-bit value. An 8-bit processor is thus able to access a maximum of 8 event memories at the same time. If there are more than 8 event memories, then such a processor needs to access event memories or groups of event memories in a plurality of successive steps.

Different methods for resetting the event memories are known from practice.

One option is for all the event memories in a group to be reset by a reset circuit as soon as the microprocessor has read the state of the group. This method does not permit individual event memories to be reset specifically, however. In addition, it requires very complex implementation of the reset circuit in order to guarantee that only those event memories which the microprocessor has detected as active when reading the group are reset, since, during read access by the microprocessor, an interrupt signal for the group may become active and hence the state of the group is altered during reading. If an event memory is reset without the microprocessor having detected the event memory as active, this event is not processed and is lost.

It is likewise known practice for all the event memories in a group or in all the groups to be reset by a program command instead of a reset circuit, with the same problems arising as in the case cited above, particularly if the state of the group is altered by new events during reading or between reading and resetting.

It is also known practice to allow the microprocessor both read access and write access to the event memories. This means that specific alteration, in particular resetting, of individual event memories is possible even when they have been combined in a group. The microprocessor reads the state of the group, alters the data value which has been read such that the event memories to be reset are erased, and writes the new state back to the group. This method may also lose events unprocessed if the state of the group is altered by new events during reading or between reading and writing. In this case, the microprocessor detects the event memories for the new events during reading as still inactive and writes this inactive state back to them, as a result of which the events are lost.

### SUMMARY OF THE INVENTION

The present invention is thus based on the object of designing an interrupt controller of the type mentioned in the introduction such that the event memories can be altered individually or else in groups on a specific basis without events being unintentionally lost in the process, which means that they cannot be processed.

This object is achieved by means of the features specified in the independent Patent Claim 1. Advantageous refinements are specified in the dependent patent claims.

The inventive interrupt controller is characterized in that the resetting signal for a particular event memory in a group becomes active when the microprocessor effects write access to the group containing this event memory using a first write signal and, at the same time, that individual signal from the microprocessor which is associated with this event memory is active on the data bus. The inventive interrupt controller thus permits the individual event memories to be reset specifically and securely by program commands.

In one advantageous implementation option for the inventive interrupt controller, the resetting signal for each event memory in a group is obtained in the form of an output signal from a logic AND function which logically combines that individual signal from the microprocessor on the data bus which is associated with the respective event memory with the first write signal which the microprocessor uses to access the event memories in this group.

Advantageously, each event memory is assigned, as individual signal from the microprocessor, the same bit of a data byte as is transferred to the microprocessor as the state of the respective event memory during read access to the appropriate group.

In one advantageous development of the inventive interrupt controller, the resetting signal for a particular event memory in a group additionally also becomes active when an interrupt acknowledgement signal from the microprocessor indicates that the interrupt routine associated with this event memory is being executed. This embodiment permits individual event memories to be reset specifically and securely both by program commands and by processor signals.

In this case, the resetting signal for each event memory in a group is advantageously obtained in the form of an output signal from a logic OR function which logically combines the appropriate interrupt acknowledgement signal with the output signal from the logic AND function, which in turn logically combines that individual signal from the microprocessor on the data bus which is associated with the respective event memory with the first write signal which the microprocessor uses to access the event memories in this group. A device ensures that the resetting signal for an event memory becomes not active if the state of an event memory is altered by new events during reading or between reading and resetting the event memory.

It is particularly advantageous if the inventive interrupt controller is designed such that the microprocessor has write access to each group of event memories using two different memory addresses, so that the microprocessor has write access to the event memories in a group using the first write signal and a second write signal.

In this case, the event memories can not only be specifically and securely reset by program commands but can also be specifically and securely set. To this end, the inventive interrupt controller is advantageously designed such that the setting signal for a particular event memory becomes active when the microprocessor effects write access to the group containing this event memory using the second write signal and, at the same time, that individual signal from the microprocessor which is associated with this event memory is active on the data bus.

With this variant of an inventive interrupt controller, it is advantageous if the setting signal for each event memory in a group is obtained in the form of an output signal from a logic OR function which logically combines an event signal associated with the respective event memory with the output signal from a logic AND function which, in turn, logically combines that individual signal from the microprocessor on the data bus which is associated with the respective event memory with the second write signal which the microprocessor uses to access the event memories in this group.

It is particularly advantageous in this context if the second memory address which the microprocessor uses to effect write access to a group is identical to the memory address which it uses to effect read access to this group, since the “read-modify-write” instructions known for a large number of microprocessors can then be used.

In another advantageous embodiment of the inventive interrupt controller, which permits not only the specific, secure resetting of individual event memories but also write access by program commands, a particular event memory is set when the microprocessor uses the second write signal to effect write access to the group containing this event memory and the individual signal associated with this event memory is active on the data bus. A particular event memory is reset when the microprocessor uses the second write signal to effect write access to the group containing this event memory and the individual signal associated with this event memory is inactive on the data bus.

In principle, the event memories can be altered, reset and set asynchronously or in clocked fashion, depending on connection.

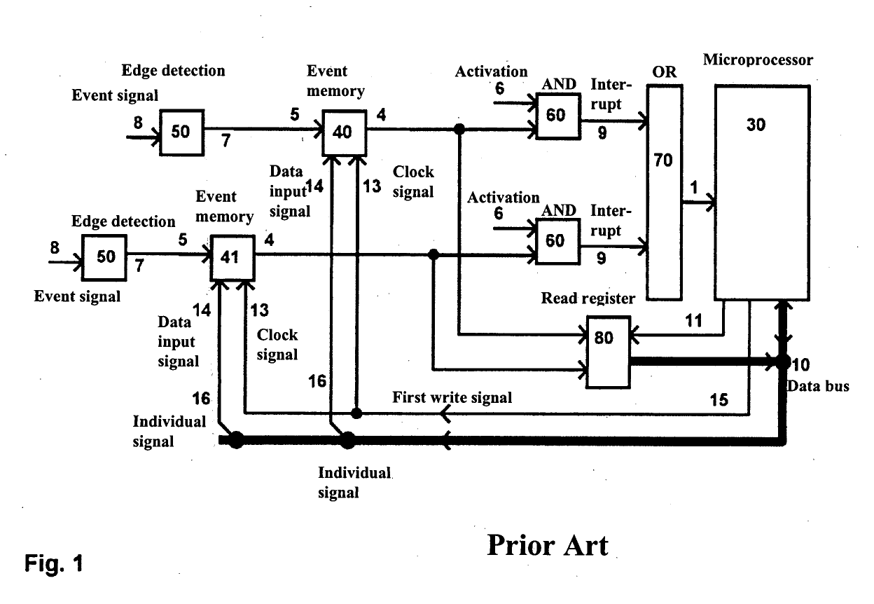

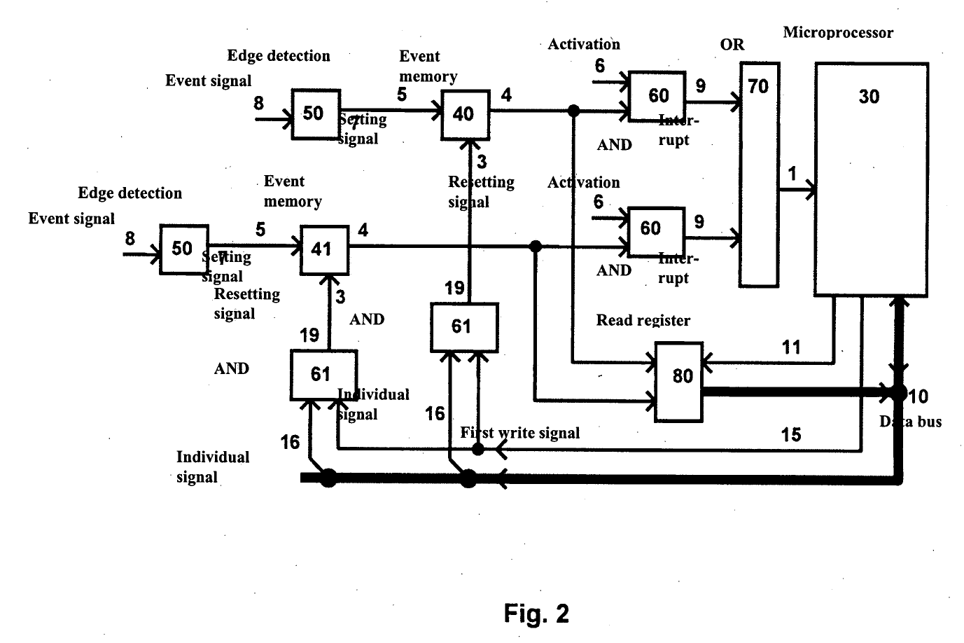

In principle, there are various options for advantageously refining and developing the disclosure of the present invention. In this regard, reference is made first to the claims subordinate to Patent Claim 1 and secondly to the explanation below of seven exemplary embodiments of the invention with reference to the drawings—FIGS. 2 to 8. To illustrate the inventive concept, the prior art on which the invention is based is also explained with reference to FIG. 1.

### BRIEF DESCRIPTION OF PREFERRED EMBODIMENTS

The invention is explained in more detail below with reference to drawings, in which:

FIG. 1 shows the basic circuit diagram for an interrupt controller from the prior art,

FIG. 2 shows the basic circuit diagram for an inventive interrupt controller permitting specific resetting of the event memories as a result of write action by the microprocessor,

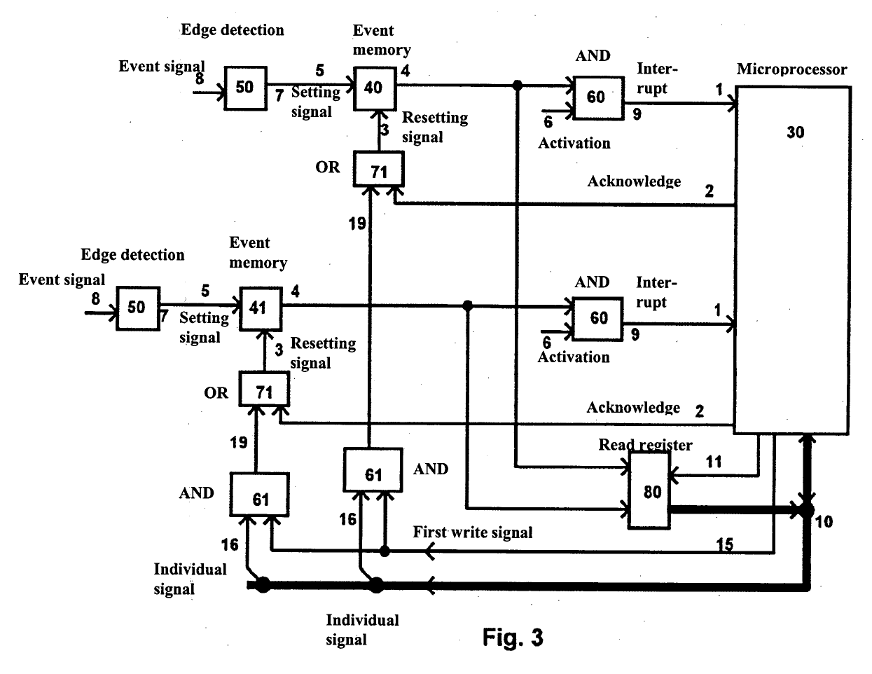

FIG. 3 shows the basic circuit diagram for an inventive interrupt controller permitting specific resetting of the event memories both as a result of write action by the microprocessor and as a result of interrupt acknowledgement signals from the microprocessor,

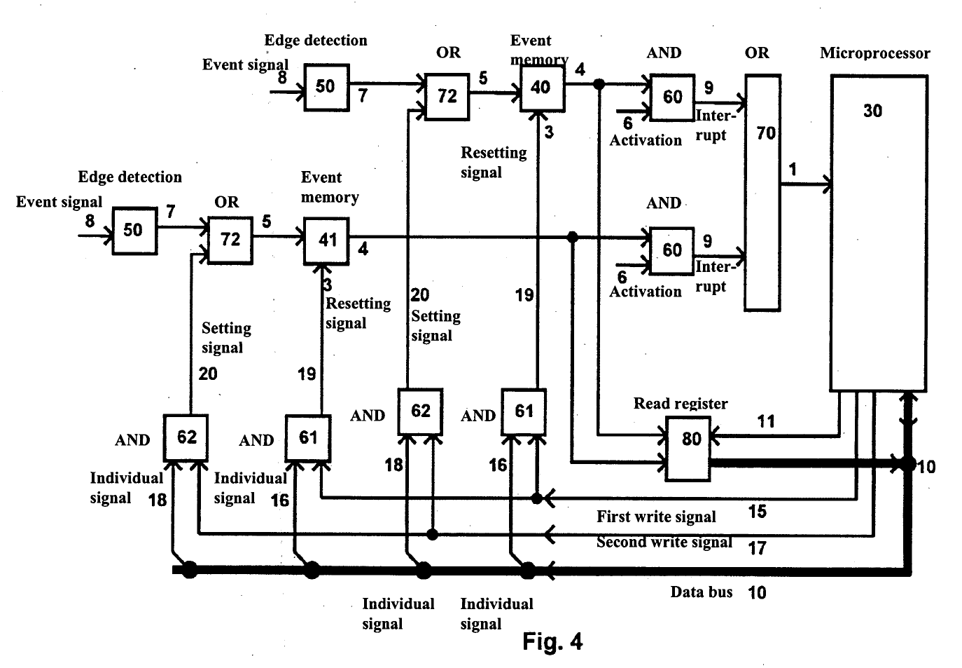

FIG. 4 shows the basic circuit diagram for an inventive interrupt controller permitting both specific resetting and specific setting of the event memories as a result of write action by the microprocessor,

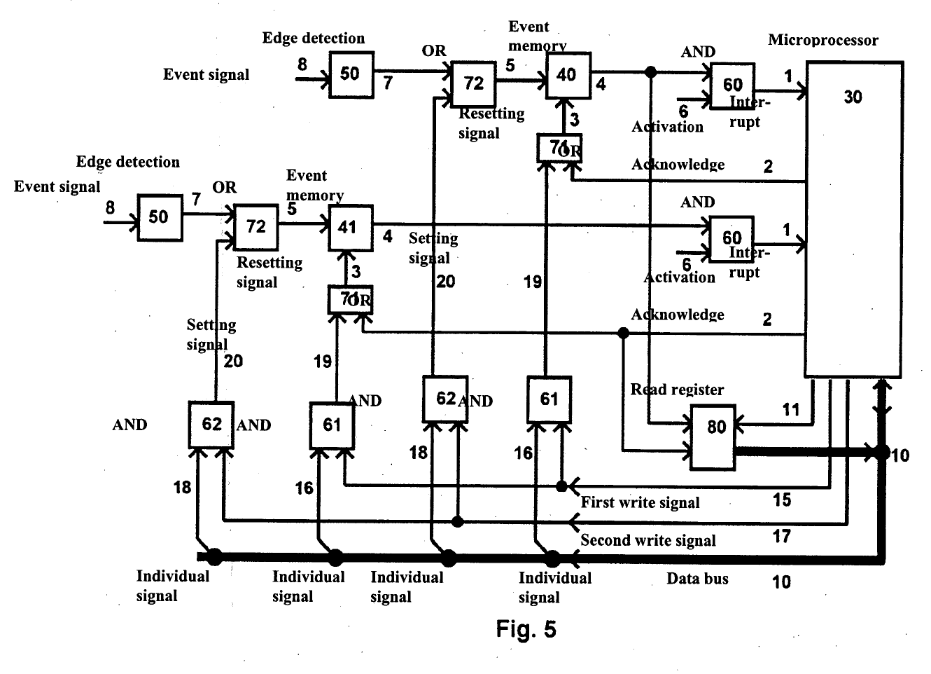

FIG. 5 shows the basic circuit diagram for an inventive interrupt controller permitting specific resetting of the event memories both as a result of write action by the microprocessor and as a result of interrupt acknowledgement signals from the microprocessor, and specific setting of the event memories as a result of write action by the microprocessor,

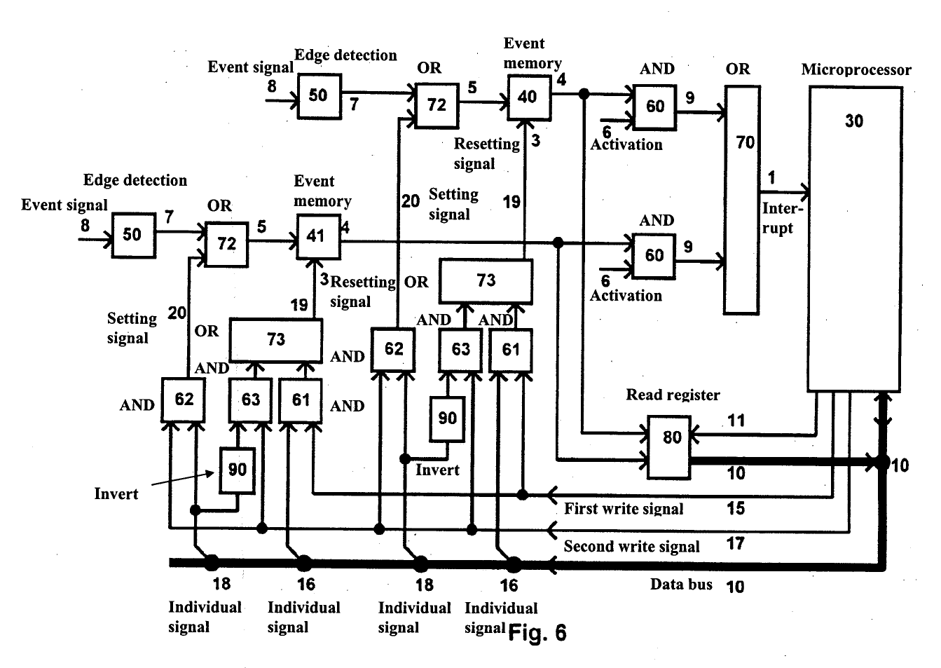

FIG. 6 shows the basic circuit diagram for an inventive interrupt controller permitting specific resetting of the event memories as a result of write action by the microprocessor, and asynchronous alteration of the event memories as a result of write action by the microprocessor,

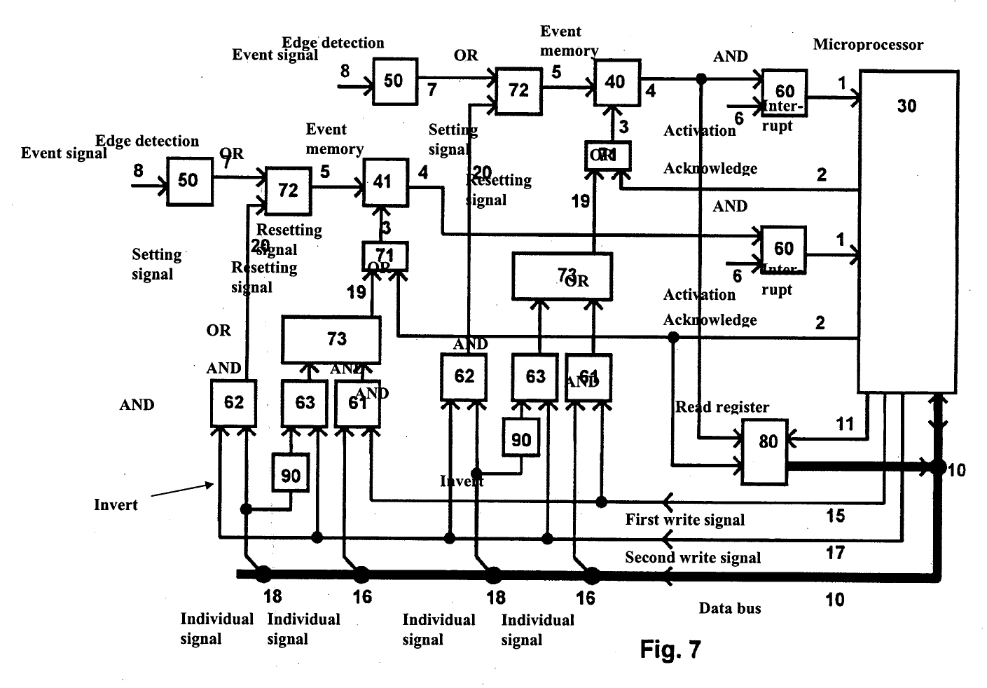

FIG. 7 shows the basic circuit diagram for an inventive interrupt controller permitting specific resetting of the event memories both as a result of write action by the microprocessor and as a result of interrupt acknowledgement signals from the microprocessor, and asynchronous alteration of the event memories as a result of write action by the microprocessor, and

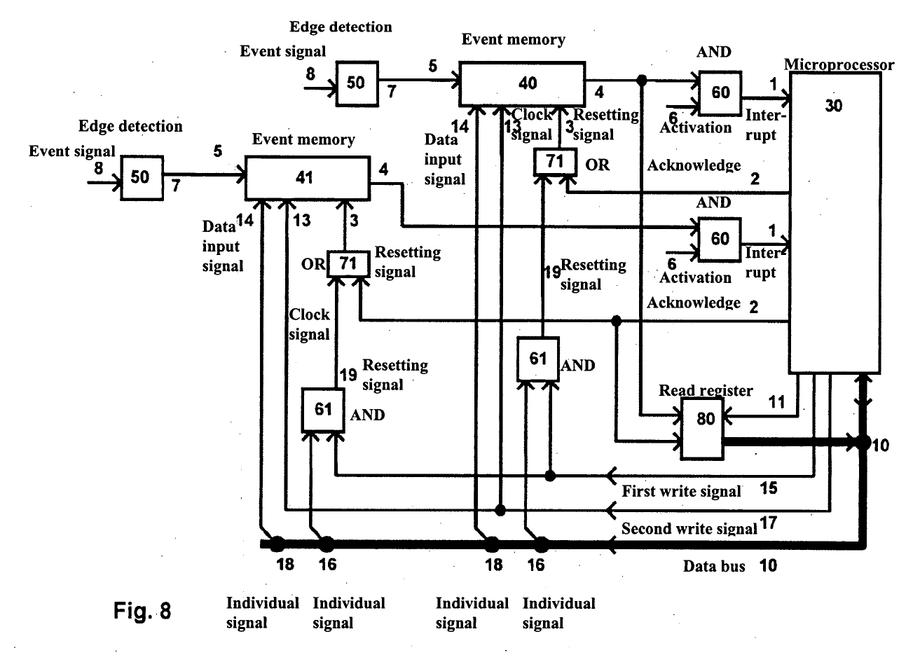

FIG. 8 shows the basic circuit diagram for an inventive interrupt controller permitting specific resetting of the event memories both as a result of write action by the microprocessor and as a result of interrupt acknowledgement signals from the microprocessor, and clocked alteration of the event memories as a result of write action by the microprocessor.

### DETAILED DESCRIPTION OF PREFERRED EMBODIMENTS

In the figures, identical circuit elements and signals have been provided with standard reference numerals.

The interrupt controller for a microprocessor 30, which interrupt controller is known from the prior art and is shown in FIG. 1, in this case comprises, by way of example, two event memories 40 and 41 which are combined to form a group. Each event memory 40 and 41 has an input for a setting signal 5, an input for a data clock signal 13 and for a data input signal 14, and an output for an event memory signal 4 portraying the state of the respective event memory 40 or 41. The setting signal 5 for an event memory 40 or 41 becomes active when activation of an event signal 8 associated with this event memory 40 or 41 is detected by an appropriate edge detection block 50. In this case, an event pulse signal 7 is transmitted from the edge detection block 50 to the event memory 40 or 41 as the setting signal 5. Arranged downstream of each of the event memories 40 and 41 is a respective interrupt activation section in the form of a logic AND function block 60 which logically combines an activation signal 6 for the interrupt events with the respective event memory signal 4. The output signals from the logic AND function blocks 60 are referred to as interrupt signals 9, which, in the example illustrated in this case, are routed via a logic OR function block 70 to an interrupt input 1 of the microprocessor 30.

When a read signal 11 from the microprocessor 30 is active, the microprocessor 30 can use a data bus 10 to retrieve the event memory signals 4 of the event memories 40 and 41 from a read register 80. In addition, the microprocessor 30 has write access to the event memories 40 and 41 when a write signal 15 from the microprocessor 30 is active. On the basis of the timing of the write signal 15 applied to the event memory 40 or 41 as a data clock signal 13, the individual signal 16 which is on the data bus 10 for the respective event memory 40 or 41 is then written to the event memory 40 or 41 as data input signal 14. In this case, each event memory 40 and 41 therefore has new information written to it with each write access operation by the microprocessor 30.

In the inventive interrupt controllers shown in FIGS. 2 to 8, each event memory 40 and 41 is respectively constructed from a memory cell having an input for a setting signal 5 and an input for a resetting signal 3 and also an output for an event memory signal 4. The event memories 40 and 41 have respectively been combined to form a group.

As in the case of the known interrupt controller shown in FIG. 1, the setting signal 5 for an individual event memory 40 or 41 becomes active when activation of the event signal 8 associated with this event memory 40 or 41 is detected. The event memory signal 4 from each event memory 40, 41 is connected to an interrupt signal 9 for the microprocessor 30 via a logic AND function block 60, so that the respective event memory signal 4 can be activated or deactivated using an activation signal 6. Advantageously, the activation signal 6 is in the form of a state signal for a data memory of the microprocessor 30.

The interrupt signals 9 are connected to an interrupt input 1 of the microprocessor 30 either directly, as in the case of FIGS. 3, 5, 7 and 8, or else via a logic OR function block 70, as in the case of FIGS. 2, 4 and 6. Using the logic OR function block 70, the interrupt signals 9 from a plurality of events can be combined on one interrupt input 1.

In the case of the inventive interrupt controllers shown in FIGS. 2 to 8, the microprocessor 30 also has read access to the event memory signals 4 from all the event memories 40 and 41 in a group as data values, as in the case of the interrupt controller shown in FIG. 1. Each memory state of the read register 80 thus represents one bit of a data byte for the microprocessor 30.

In the interrupt controller shown in FIG. 2, the resetting signal 3 for an event memory 40 or 41 becomes active when the microprocessor 30 effects write access to the group containing this event memory 40 or 41 and, at the same time, that individual signal 16 from the microprocessor 30 which is associated with this event memory 40 or 41 in the group is active on the data bus 10. The microprocessor 30 ensures that the resetting signal 3 for an event memory becomes not active if the state of an event memory 40 is altered by new events during reading or between reading and resetting the event memory 40. This advantageously involves using the same bit of a data byte by virtue of the state of the event memory 40 or 41 also being transferred to the microprocessor 30 during read access to the appropriate group. To this end, the write signal 15 from the microprocessor 30 and the individual signal 16 for an event memory 40 or 41 are logically combined by means of a logic AND function block 61 whose output signal forms a software-controlled resetting signal 19 for the respective event memory 40 or 41. The embodiment of an inventive interrupt controller shown in FIG. 2 thus permits specific, secure resetting of individual event memories 40 and 41 by program commands.

In the case of the interrupt controller shown in FIG. 3, by contrast with the variant shown in FIG. 2, the resetting signal 3 for an event memory 40 or 41 additionally also becomes active when an interrupt acknowledgement signal 2 from the microprocessor 30 indicates that the interrupt routine associated with this event memory 40 or 41 is being executed. To this end, the interrupt acknowledgement signal 2 from the microprocessor 30 and the software-controlled resetting signal 19 for the respective event memory 40 or 41 are logically combined by means of a logic OR function block 71 whose output signal forms the resetting signal 3 for the respective event memory 40 or 41. In this variant of an inventive interrupt controller, individual event memories 40 and 41 can be specifically and securely reset both by program commands and by processor signals.

In the inventive interrupt controllers shown in FIGS. 4 to 8, the microprocessor has write access to each group of event memories 40 and 41 using two different memory addresses.

In the case of write access by the microprocessor 30 under the first memory address using the first write signal 15 from the microprocessor 30, the resetting signal 3 for an event memory 40 or 41 becomes active as described in connection with FIG. 2. In addition, the setting signal 5 for an event memory 40 or 41 becomes active not only when activation of the event signal 8 associated with this event memory 40 or 41 is detected, but also when the microprocessor effects write access to the group containing this event memory 40 or 41 under the second memory address using the second write signal 17 from the microprocessor 30 and, at the same time, that individual signal 18 on the data bus 10 which is associated with this event memory 40 or 41 in the group is active. This advantageously involves using the same bit of a data byte by virtue of the state of the appropriate event memory 40 or 41 also being transferred to the microprocessor 30 during read access to the group. In addition, the second memory address, which the microprocessor 30 uses to effect write access to the group, is advantageously identical to the memory address which it uses to effect read access to this group. This is because the “read-modify-write” instructions known for a large number of microprocessors can be used in this case. To this end, the write signal 17 from the microprocessor 30 and the individual signal 18 for an event memory 40 or 41 are logically combined by means of a logic AND function block 62 whose output signal forms a software-controlled setting signal 20 for the respective event memory 40 or 41. This setting signal 20 is logically combined with the event pulse signal 7 by means of a logic OR function block 72. The output signal from the logic OR function block 72 then forms the setting signal 5 for the respective event memory 40 or 41.

The embodiment of an inventive interrupt controller described above is shown in FIG. 4 and permits specific, secure resetting and setting of individual event memories 40 or 41 by program commands. This variant can be combined with the option of resetting using interrupt acknowledgement signals 2, as described in connection with FIG. 3, which is shown in FIG. 5.

In the variants of an inventive interrupt controller shown in FIGS. 6 to 8, besides specific resetting of the event memories 40 and 41 as a result of write action by the microprocessor 30, it is also possible for the event memories 40 and 41 to be altered as a result of write action by the microprocessor 30. The event memories 40 and 41 are altered whenever the microprocessor 30 effects write access to the group containing the respective event memory 40 or 41 using the second memory address. In the case of the interrupt controllers shown in FIGS. 6 and 7, in that instance, either the appropriate setting signal 5 becomes active, if that individual signal 18 from the microprocessor 30 which is associated with this event memory 40 or 41 in the group is active, or the corresponding resetting signal 3 becomes active, if that individual signal 18 from the microprocessor 30 which is associated with this event memory 40 or 41 in the group is inactive. This advantageously involves using the same bit of a data byte by virtue of the state of the respective event memory 40 or 41 also being transferred to the microprocessor 30 during read access to the appropriate group. In addition, the second memory address which the microprocessor 30 uses to effect write access to the group is advantageously identical to the memory address which it uses to effect read access, so that the “read-modify-write” instructions known for a large number of microprocessors can be used.

In the embodiment of an inventive interrupt controller shown in FIG. 6, the event memories 40 and 41 are specifically reset and altered using a respective logic OR function block 73 whose output signal forms the reset signal 3 for an event memory 40 or 41 and which logically combines the output signals from two logic AND function blocks 61 and 63 with one another. The logic AND function block 61 logically combines the first write signal 15 from the microprocessor 30 with that individual signal 16 on the data bus 10 of the microprocessor 30 which is associated with the respective event memory 40 or 41, which produces the specific resetting of the event memory 40 or 41. The logic AND function block 63 logically combines the second write signal 17 from the microprocessor 30 with that individual signal 18 on the data bus 10 of the microprocessor 30 which is associated with the respective event memory 40 or 41 but which has been inverted previously using an inverting block 90. In addition, that individual signal 18 on the data bus 10 of the microprocessor 30 which is associated with the respective event memory 40 or 41 is also logically combined with the second write signal 17 from the microprocessor 30 by means of a logic AND function block 62. This logic AND function block 62 delivers a software-controlled setting signal 20 which is logically combined with the event pulse signal 7 from the edge detection block 50 for the respective event memory 40 or 41 by means of a logic OR function block 72. The output signal from this logic OR function block 72 is used as the setting signal 5 for the respective event memory 40 or 41.

By contrast with the circuit arrangement shown in FIG. 6, the circuit arrangement shown in FIG. 7 is complemented merely by the option of the event memories 40 and 41 also being specifically reset by interrupt acknowledgement signals 2 from the microprocessor 30.

In the case of the interrupt controller shown in FIG. 8, the event memories 40 and 41 are each directly overwritten with their associated individual signal 18 which is on the data bus 10 when the second write signal 17 is active. To this end, the write signal 17 is routed to the event memory 40 or 41 as a data clock signal 13, while the individual signal 18 which is on the data bus 10 forms a data input signal 14 for the event memory 40 or 41.

The embodiments of the invention which have been described here are indicated merely by way of example. On the basis of the disclosure of the invention, a person skilled in the art can implement other embodiments of an interrupt controller which remain within the scope of the invention.

1. Interrupt controller for a microprocessor having a plurality of event memories which are combined to form at least one group and each have an input for a setting signal and an output for an event memory signal which portrays the state of the event memory,
where the setting signal for an event memory becomes active when activation of an event signal associated with this event memory is detected,
where the event memory signals are connected to an interrupt signal for the microprocessor,
where the microprocessor has read and write access to the event memory signals via a data bus, and
where the event memories each have an input for a resetting signal,
wherein the resetting signal for an event memory in a group becomes active when the microprocessor effects write access to the group containing this event memory using a first write signal and, at the same time, that individual signal from the microprocessor which is associated with this event memory is active on the data bus; and means for ensuring that the resetting signal for an event memory becomes not active if the state of an event memory is altered by new events during reading or between reading and resetting the event memory.

2. Interrupt controller according to claim 1, wherein the resetting signal for each event memory in a group is obtained in the form of an output signal from a logic AND function which logically combines that individual signal from the microprocessor on the data bus which is associated with the respective event memory with the first write signal (15) which the microprocessor uses to access the event memories in this group.

3. Interrupt controller according to claim 1, wherein each event memory is assigned, as individual signal from the microprocessor, the same bit of a data byte as is transferred to the microprocessor as the state of the respective event memory during read access to the appropriate group.

4. Interrupt controller according to claim 1, wherein the resetting signal for an event memory in a group also becomes active when an interrupt acknowledgement signal from the microprocessor indicates that the interrupt routine associated with this event memory is being executed.

5. Interrupt controller according to claim 4, wherein the resetting signal for each event memory in a group is obtained in the form of an output signal from a logic OR function which logically combines the appropriate interrupt acknowledgement signal with an output signal from a logic AND function, which in turn logically combines that individual signal from the microprocessor on the data bus which is associated with the respective event memory with the first write signal which the microprocessor uses to access the event memories in this group.

6. Interrupt controller according to claim 1, wherein the microprocessor has write access to each group of event memories using two different memory addresses, so that the microprocessor has write access to the event memories in a group using the first write signal and a second write signal, and in that the setting signal for an event memory becomes active when the microprocessor effects write access to the group containing this event memory using the second write signal and, at the same time, that individual signal from the microprocessor which is associated with this event memory is active on the data bus.

7. Interrupt controller according to claim 6, wherein the setting signal for each event memory in a group is obtained in the form of an output signal from a logic OR function which logically combines an event signal associated with the respective event memory with the output signal from a logic AND function which, in turn, logically combines that individual signal from the microprocessor on the data bus which is associated with the respective event memory with the second write signal which the microprocessor uses to access the event memories in this group.

8. Interrupt controller according to claim 6, wherein the second memory address which the microprocessor uses to effect write access to a group is identical to the memory address which it uses to effect read access to this group.

9. Interrupt controller according to claim 6, wherein an event memory is set when the microprocessor uses the second write signal to effect write access to the group containing this event memory and the individual signal associated with this event memory is active on the data bus, and in that an event memory is reset when the microprocessor uses the second write signal to effect write access to the group containing this event memory and the individual signal associated with this event memory is inactive on the data bus.

10. Device for recording or reproducing information on an optical information medium, wherein the device comprises an interrupt controller according to claim 1.
